(19) United States
(12) Patent Application Publication
(10) Pub. No.: US 2024/0264441 A1
(43) Pub. Date: Aug. 8, 2024

(54) SYSTEM, APPARATUS, AND METHOD FOR INTEGRATION OF FACIAL NONVERBAL COMMUNICATION IN EXTRAVEHICULAR ACTIVITY OR SPACE OPERATIONS

(71) Applicant: Avner Bendheim, Jerusalem (IL)

(72) Inventor: Avner Bendheim, Jerusalem (IL)

(21) Appl. No.: 18/435,361

(22) Filed: Feb. 7, 2024

Related U.S. Application Data
(60) Provisional application No. 63/483,745, filed on Feb. 7, 2023.

(51) Int. Cl. G02B 27/01; A42B 3/04; G02B 27/00

(52) U.S. Cl. CPC G02B 27/0172; A42B 3/042; G02B 27/0093; G02B 2027/0138

(57) ABSTRACT

A system, apparatus, and method for integration of facial nonverbal communication in extravehicular activity is disclosed. The system may include a photo realistic digital twin of an EVA crewmember and a helmet for an EVA suit. The helmet may include a visor assembly. The visor assembly may include a first visual display which includes a first display area facing the helmet. The visor may include a second visual display with a second display area which faces away from the helmet. A digital camera inside the helmet may capture a live image of the EVA crewmember. An avatar image of the EVA crewmember may be generated in real-time based on the live image and the photorealistic digital twin. The avatar image may be exhibited in real-time on the second display. Another EVA crewmember may decode a facial nonverbal communication signal in the avatar image during EVA training or space operations.

### CROSS-REFERENCE TO RELATED APPLICATIONS

This application claims the benefit of U.S. Provisional Application No. 63/483,745 filed Feb. 7, 2023, the entire disclosure of which is incorporated by reference herein.

### FIELD OF THE INVENTION

The present disclosure relates to a system and method for integrating nonverbal communication in team operations. More particularly, the disclosure relates to a communication system which may be used by pressure-suited crewmembers to communicate nonverbally during extravehicular activity.

### BACKGROUND

Extravehicular Activity (EVA) may be any activity performed by a pressure-suited crewmember in unpressurized or space environments. For instance, EVA may include spacewalks and lunar or planetary surface exploration. Spacesuits may protect astronauts during EVA, as well as provide functionality for performing tasks outside of a spacecraft or module. For example, EVA suits may include an audio or video communication system to provide an open channel for communication between an EVA crew and mission control center (MCC). Still, mission requirements, environmental conditions or technical capabilities of a spacesuit may challenge the ability of EVA crew to interact or collaborate. Accordingly, a need exists for systems and methods which facilitate communication between EVA crew during space operations.

### SUMMARY

Hence, a method for integration of facial nonverbal communication between EVA crew during space operations is disclosed. For instance, the method may include providing a photo realistic digital twin of an EVA crewmember and providing a helmet for an EVA suit. The helmet may include a visor assembly which includes a first visual display for a first communication channel. The first visual display may include a first display area facing the helmet. The visor assembly further may include a second visual display for a second communication channel, the second visual display being spaced from the first visual display. The second visual display may include a second display area, the second display area facing away from the helmet. Moreover, the visor assembly may include a shade disposed between the first visual display and the second visual display. Also, the helmet may include a digital camera disposed inside the helmet. The method further may include capturing a live image of the EVA crewmember with the digital camera, creating an avatar image of the EVA crewmember in real-time based on the live image of the EVA crewmember and the photo realistic digital twin for the EVA crewmember and transforming the avatar image of the EVA crewmember into an electronic signal. Further, the method may include presenting the avatar image of the EVA crewmember in real-time on the second display area and transmitting a facial nonverbal communication signal from the EVA crewmember to the second display area in the avatar image. The shade may include an LCD for reflecting sunlight away from the helmet. The first display area may be a HUD. In one embodiment, the second display area may include a transmissive one-side-emission OLED panel. In another embodiment, the second display area may include an exterior surface of the visor assembly.

Additionally, an apparatus for integration of facial nonverbal communication in extravehicular activity is disclosed. The apparatus may include a helmet for an EVA suit. The helmet may include a visor assembly. The visor assembly may include a first visual display for a first communication channel. The first visual display may include a first display area facing the helmet. Moreover, the visor assembly may include a second visual display for a second communication channel, the second visual display being spaced from the first visual display. The second visual display may include a second display area. The second display area may face away from the helmet. Further, the visor assembly may include a shade disposed between the first visual display and the second visual display. The helmet also may include a digital camera disposed inside the helmet. In a preferred embodiment of the apparatus, the shade may include an LCD for reflecting sunlight away from the helmet, the first display area may be a HUD, and the second display area may include a transmissive one-side-emission OLED panel.

Also, a system for integration of facial nonverbal communication in extravehicular activity is disclosed. The system may include one of the apparatus embodiments and a photo realistic digital twin of an EVA crewmember. Further, the system may include a protocol for facial nonverbal communication in EVA space operations or training.

### DESCRIPTION OF THE DRAWINGS

In the accompanying drawings, which form a part of the specification and are to be read in conjunction therewith and in which like reference numerals (or designations) are used to indicate like parts in the various views:

FIG. 1 depicts an astronaut in an illustrative EVA suit performing space operations;

FIG. 2A presents a first part of a process flow chart for integration of a facial nonverbal communication channel in EVA or team operations;

FIG. 2B presents a second part of the process flow chart for integration of a facial nonverbal communication channel in EVA or team operations;

FIG. 3 depicts an exemplary system for creating a 3-D profile of an EVA crewmember's face;

FIG. 4 presents an exemplary facial expression classification system;

FIG. 5 depicts the development of a model or digital twin of the EVA crewmember based on a collection of 3-D profiles of the EVA crewmember's face, which may include photorealistic representations of the EVA crewmember rehearsing the facial expressions of FIG. 4;

FIG. 6 depicts an illustrative EVA crewmember's face captured by live video next to an avatar of the EVA crewmember generated in real time from the model or digital twin of the EVA crewmember and the live video signal;

FIG. 7 is a schematic representation of an exemplary helmet for an EVA suit;

FIG. 8 depicts a plurality of cameras (or measurement devices) which may be located on the periphery of the helmet to capture live images (or maps) of the EVA crewmember's face;

FIG. 9 is a schematic diagram of an exemplary embodiment of a nonverbal communication system for a helmet of an EVA suit, including an inward facing display area;

FIG. 10 is a schematic diagram of exemplary embodiment of a nonverbal communication system for a helmet of an EVA suit, including an outward facing display area;

FIG. 11 is a schematic diagram of an exemplary embodiment of a nonverbal communication system for a helmet of an EVA suit, including a projector which projects images of an avatar of the EVA crewmember on to an outward facing display area located on an external part of the helmet bubble or face shield;

FIG. 12 is a schematic diagram of an exemplary embodiment of a nonverbal communication system for a helmet of an EVA suit, including a transparent outward facing display, the transparent outward facing display including a transmissive single-sided display area located within the helmet bubble or face shield;

FIG. 13 shows an illustrative transmissive one-side-emission OLED panel;

FIG. 14 illustrates an avatar image of an EVA crewmember displayed on an outward facing display area of the EVA crewmember's helmet during space operations.

### DESCRIPTION

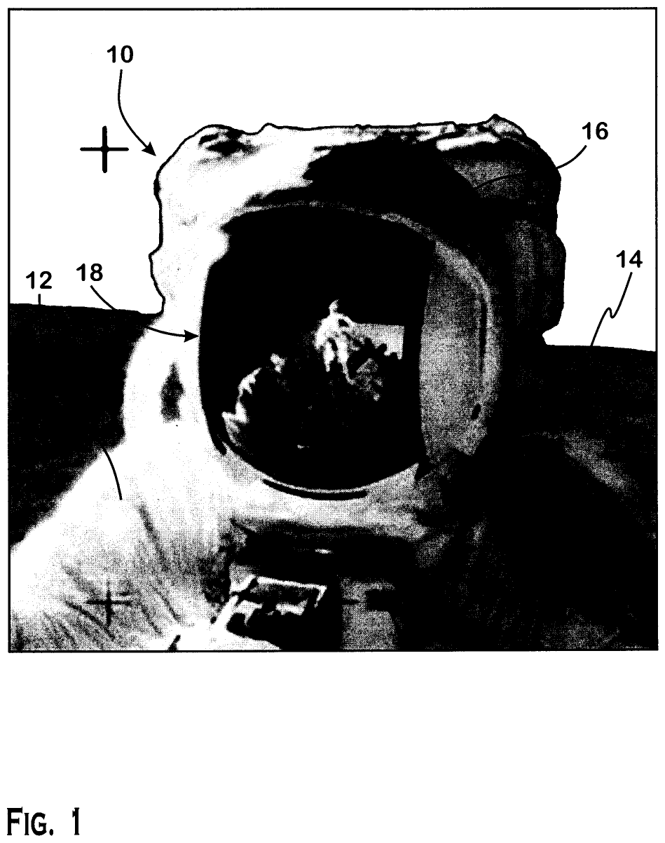

FIG. 1 shows an astronaut (or EVA crewmember) 10 in an illustrative EVA suit 12 performing space operations on the lunar surface 14 in direct sunlight. The EVA suit 12 includes a helmet 16. The helmet 16 includes a visor assembly 18. The visor assembly 18 may be formed from a plurality of visors or eyeshades. Generally, visors or eyeshades may be deployed to reflect or absorb sunlight. For example, exposure to direct sunlight may subject the astronaut to dangerous levels of ultraviolet light which may blind or otherwise directly harm the astronaut. Moreover, infrared radiation incident to the helmet space may cause uncontrolled heating of the helmet interior. Additionally, the visor assembly 18 may enhance visibility, prevent eye strain, and reduce fatigue.

A deployed visor assembly 18, however, may prevent EVA crew from seeing each other's faces, and thus limit nonverbal communication between EVA crew to hand gestures or signals. See, FIG. 1. The inability of an EVA crewmember to observe the facial expressions of another EVA crewmember may significantly hinder communication and the ability to cooperate with operational activities. Accordingly, the capability of integrating facial nonverbal communication between EVA crew may beneficially supplement audio communication, and thus enhance EVA crew performance of space operations. Also, in a potentially stressful or dangerous situation the ability of EVA crewmembers to connect through sight may be reassuring, help to diffuse tension, or allow for interpersonal communication where audio communication is not available or hand signals are not practicable.

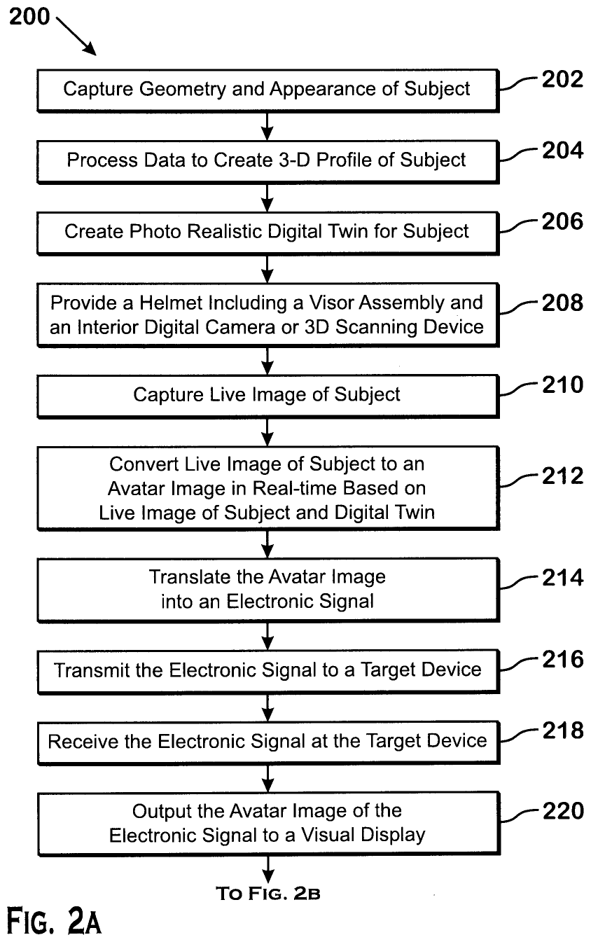

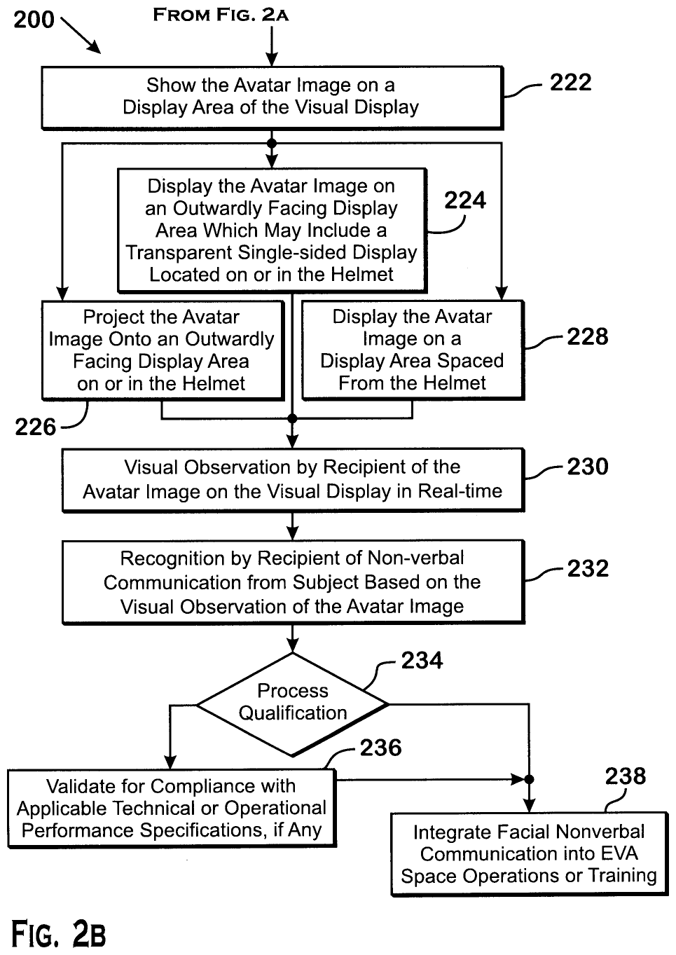

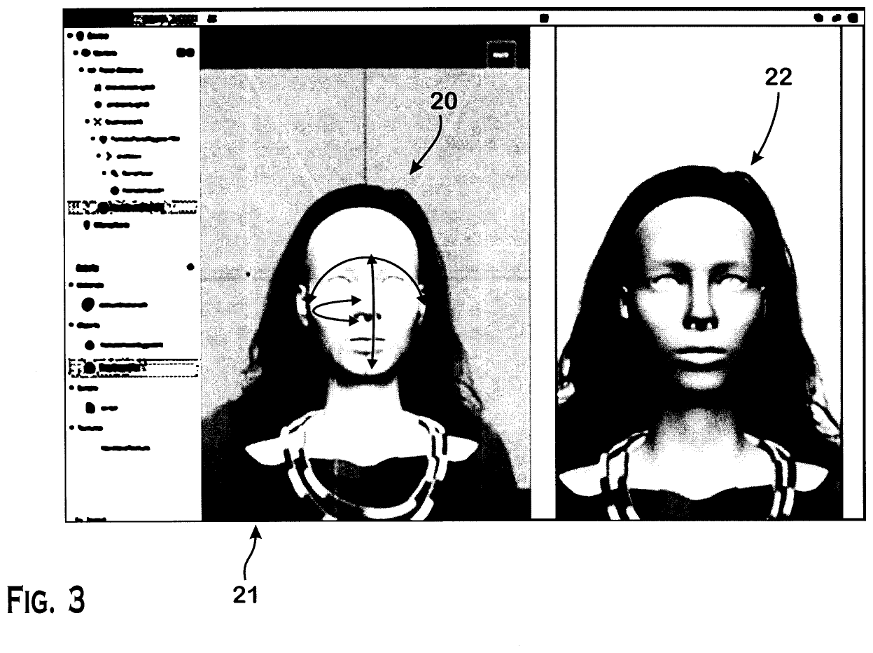

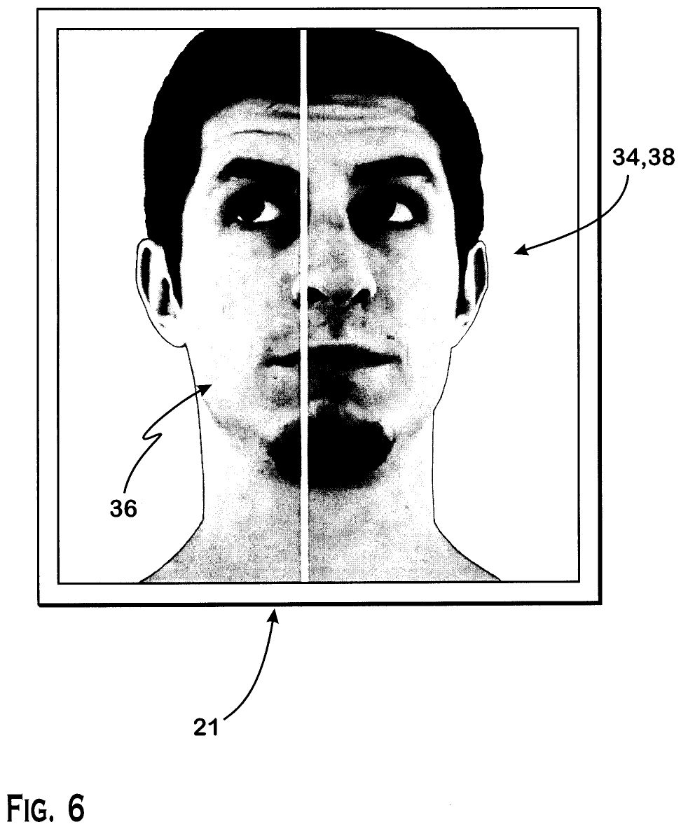

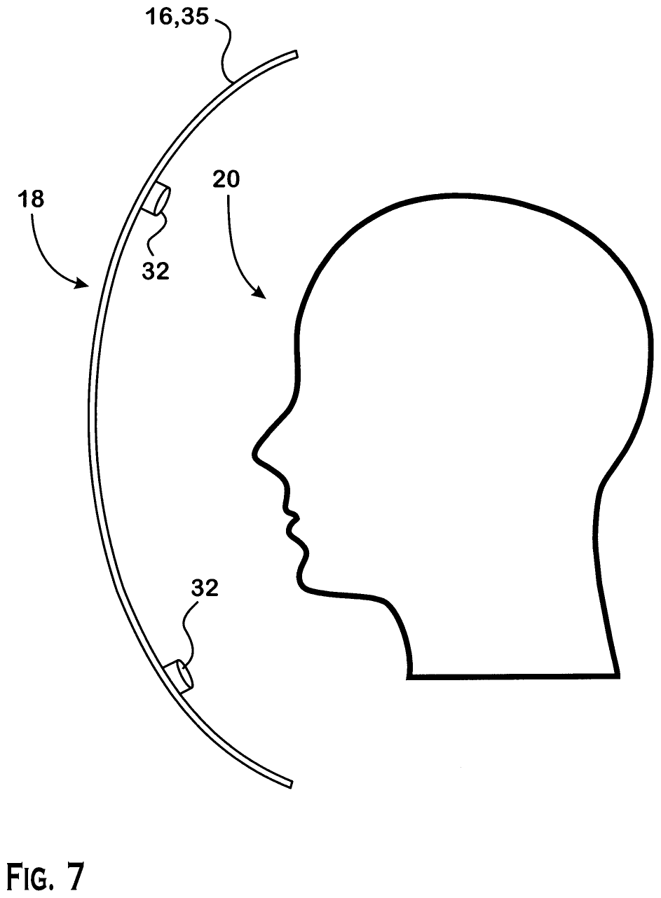

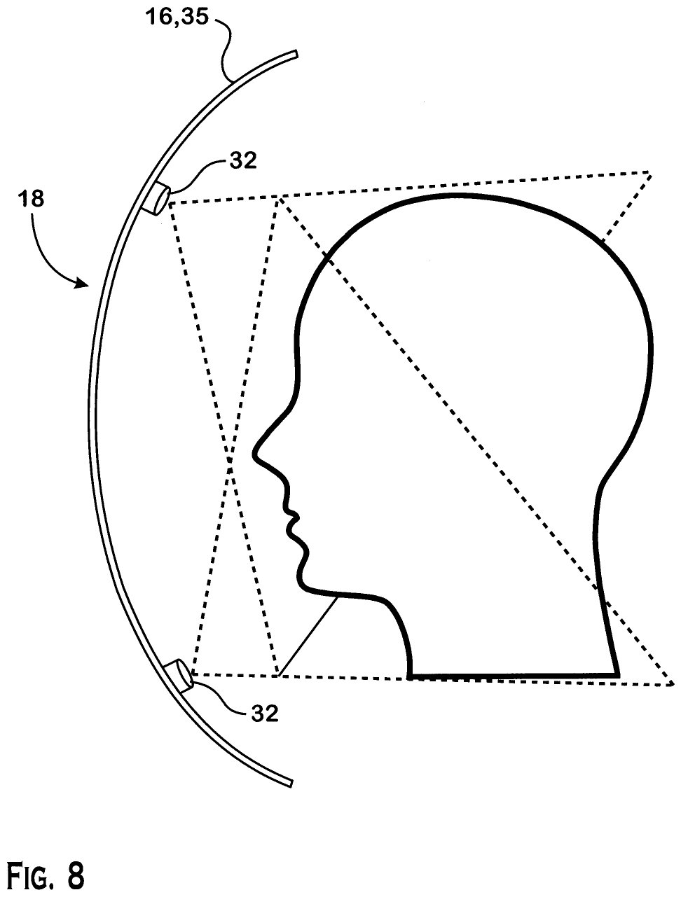

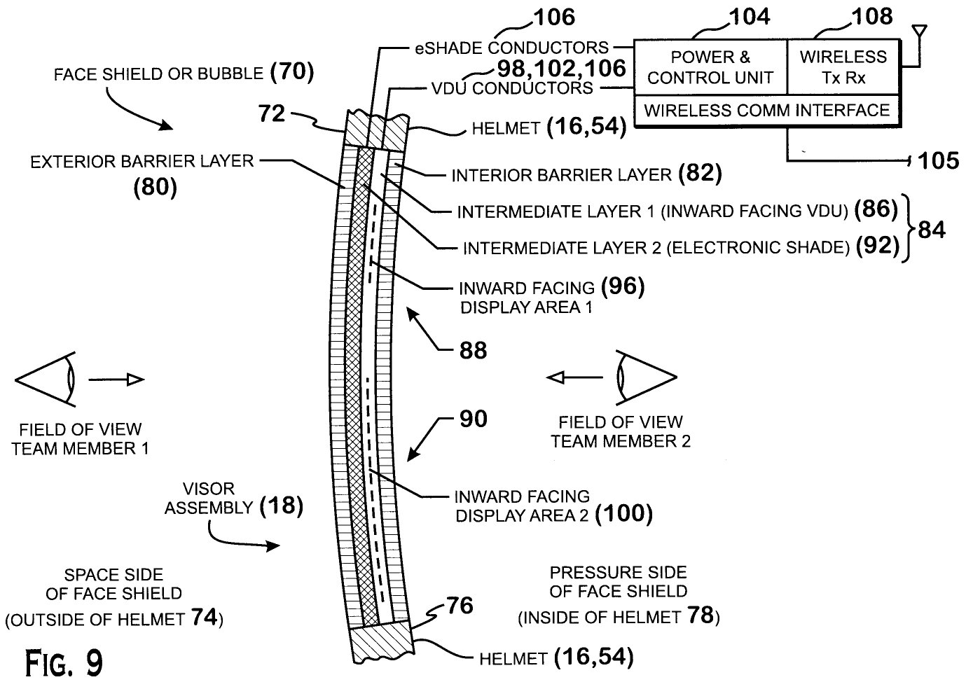

FIGS. 2A and 2B present a process flow chart 200 for implementing a method of facial nonverbal communication in EVA or other team operations. Generally, the method may include: creating a photorealistic digital twin of each EVA crewmember's face 206 (see e.g., FIGS. 3, 4 and 5); providing a helmet including an interior digital camera or 3D scanning device 208 (see e.g., FIG. 7); capturing the state of one EVA crewmember's face within the helmet of an EVA suit 210 (see e.g., FIG. 8), converting these data into a photorealistic avatar capable of reproducing subtle facial expressions 212 (e.g., FIG. 6), and displaying the photorealistic avatar in real time 222 to another EVA crewmember 230 (see e.g., FIGS. 9, 11, 12 and 14). The method may further include validating the system 236 for mission specific operational performance requirements or technical specifications. Also, the method may include integrating facial nonverbal communication into team operations 238. For instance, the method 200 may include developing a nonverbal communication protocol or signals involving a facial expression (or sequence of facial expressions) for exchanging information. The nonverbal communication protocol or signals may be integrated into EVA space operations or training. For example, a common protocol for facial nonverbal communication may include initiating a message with a call sign, tracking a thread of communication to which the message relates, transmitting the body of the message, and ending the message, each with a specific facial expression or sequence of facial expressions.

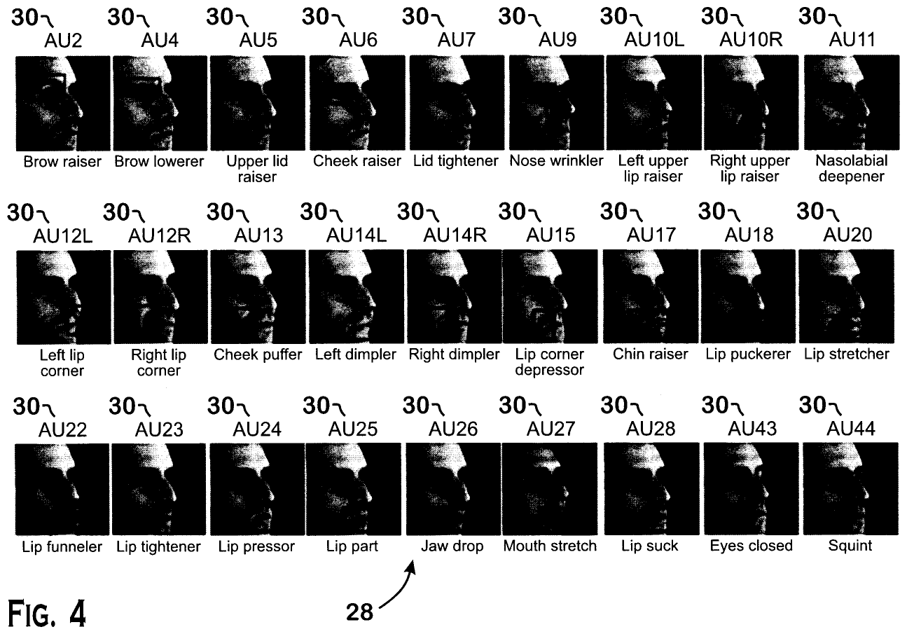

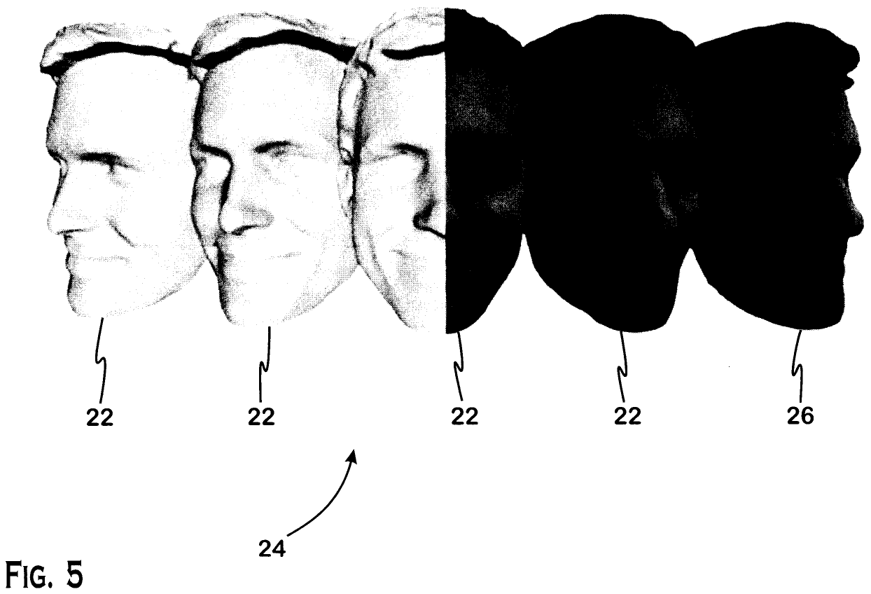

Referring to FIGS. 2A, 3 and 5, an EVA crewmember's face 20 may be modeled in advance. For instance, a set of 360° degree cameras and scanners similar to image recording studios developed for commercially available software technology 21— e.g., Meta's (formerly Facebook) Codec Avatar™—may be used to collect data or create a three-dimensional (3D) profile 22 of the EVA crewmember's face 20 or head. See e.g., FIG. 3. As depicted in FIG. 5, a 3D model 24 of the astronaut's face 20 and facial expressions may be mapped and analyzed to create a photorealistic digital twin 26. For instance, the astronaut's face and facial expressions may be mapped and analyzed using a facial coded system such as the facial action coding system (FACS) 28. See FIG. 4. For example, FACS 28 may be used to objectively decompose minute facial expressions into action units (AU) 30, a variety of detailed facial components, and correlated muscles. FACS based analysis or similar techniques may enable automated computing systems to accurately detect as well as digitally reproduce nearly any human facial expression. In this manner, a photorealistic digital twin 26 may be created for each EVA crewmember's head, including minute facial expressions. See e.g., FIG. 5.

Referring to FIGS. 2A and 7, the method 200 further may include the use of imaging devices 32 (e.g., digital cameras, 3D scanners or lidar system components) positioned strategically within the helmet 16 to record facial movements of an EVA crewmember wearing the helmet 35. For example, one imaging or tracking device 32 may be located on the upper right or left corner of the visor assembly 18, and a second imaging or tracking device 32 may be located on the lower opposite corner. Although these imaging or tracking devices 32 may be miniature and lightweight cameras like ones installed in advanced VR headsets, these devices may include, alone or in combination, other digital cameras, 3D scanners, optical devices, Lidar system components, or other applicable technology.

Referring to FIGS. 2A, 5, 6 and 8, after a 3D model 24 of the EVA crewmember's face 20 has been created (see e.g., FIG. 5), an avatar 34 (see e.g., FIG. 6) may be generated in real-time based on a live image 36 or data from the cameras, sensors, or motion tracking devices 32 installed within the EVA crewmember's helmet 35. The display of an avatar image 38 may overcome technical constraints associated with projecting a video image of the EVA crewmember's face. For instance, a video image of the EVA crewmember's face may require placement of a camera directly in front of the astronaut's face, which may obstruct the EVA crewmember's field of view (FOV). Also, the display of an avatar image 38 may allow for an unobstructed view of the EVA crewmember's (digital) face, irrespective of the lighting conditions, filmed angle, or quality of the camera. Referring to FIG. 6, suitable software technology 21 for converting a live image 36 of the EVA crewmember's face 20 into an avatar image 38 in real time may include Spark AR™ or Codec Avatar™ technologies developed by Meta's (formerly Facebook's) Reality Labs. Thus, advanced motion tracking and graphics software may be used (or developed) to detect and artificially simulate subtle facial movements, creating realistic representations of crewmembers in real-time.

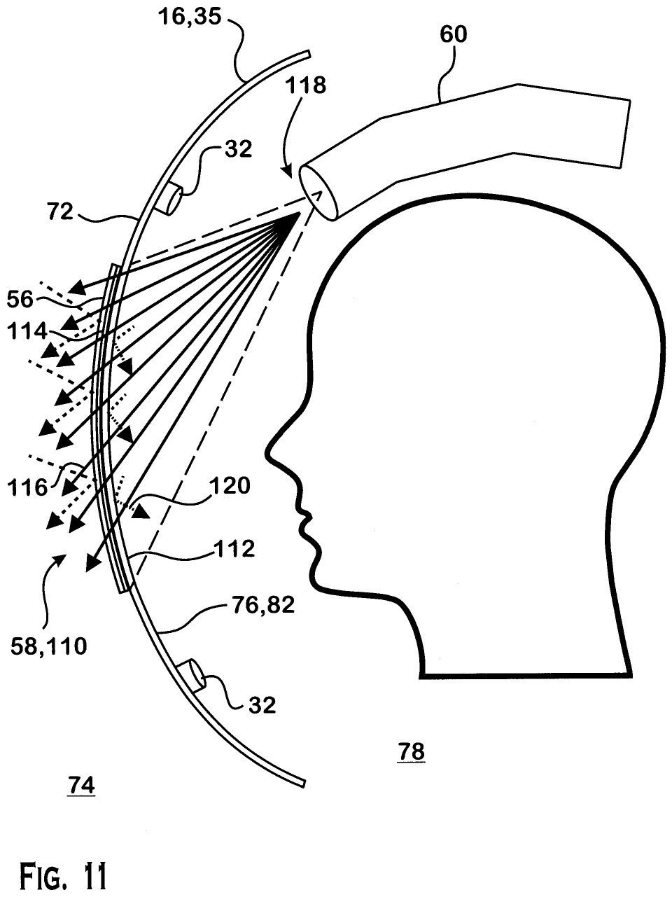

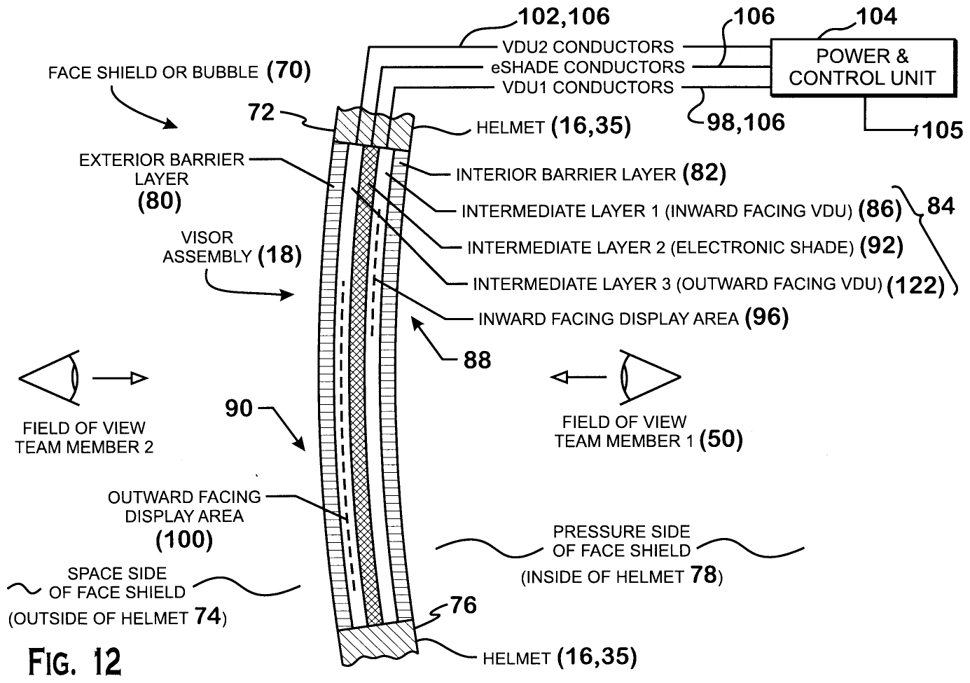

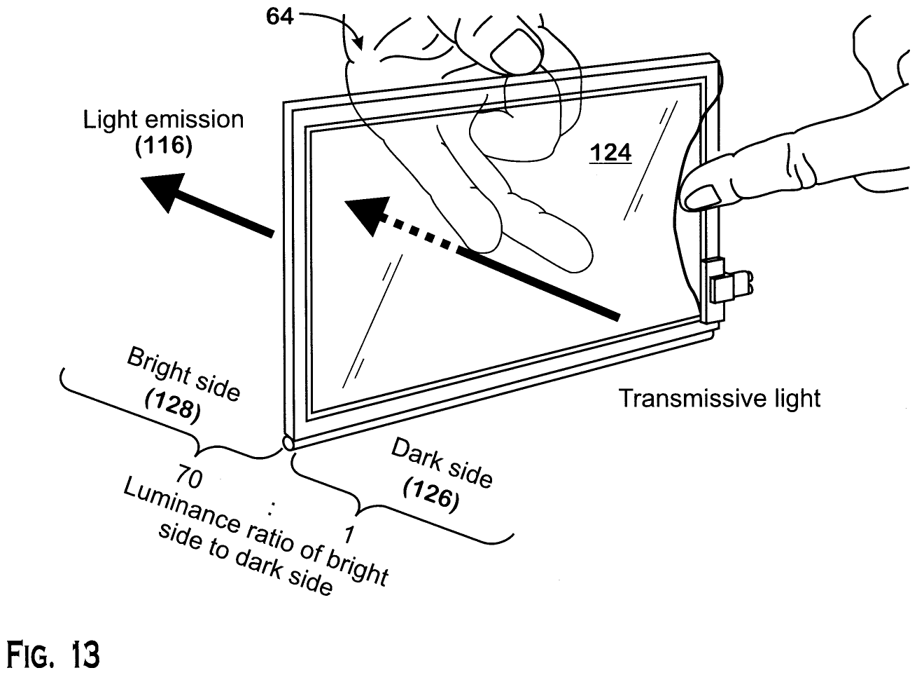

Referring to FIG. 2A and FIG. 11, the method 200 may include the step 234 of translating the avatar image 38 into an electronic signal. Additionally, the method 200 may include the step 216 of transmitting the electronic signal to a target device (e.g., a networked component, projector or video display unit). Moreover, the method 200 may include the step of 218 receiving the electronic signal at the target device and the step 220 of outputting the avatar image 38 to a visual display. In FIG. 11, the target device may be a projector 60 and the visual display 58 may include a display area 110 located on an outside surface of the EVA crewmember's face shield 56. Referring to FIG. 9, the visual display 90 may include an inward facing display area 100 located in another EVA crewmember's helmet 54. Referring to FIG. 12, the visual display 90 may include an outward facing display area 100 in the face shield or bubble 70 of the EVA crewmember's helmet 35. For instance, the outward facing display area 100 may include a transmissive one-side-emission OLED panel 64 or similar device. See e.g., FIG. 13. In another embodiment, however, the outward facing display area 100 may be part of an OLED display (or similar device) which obstructs the EVA crewmember's field of view 50. Instead of having a generally clear field of view 50 through the face shield or bubble 70, one or more cameras or imaging devices may be arranged in or on the helmet to capture a visual image of the external environs of the helmet. For instance, the captured visual image may be a substitute for the obstructed field of view or another view. The captured visual image may be processed and displayed on the first display area. Also, the second display area 100 may be a flexible device.

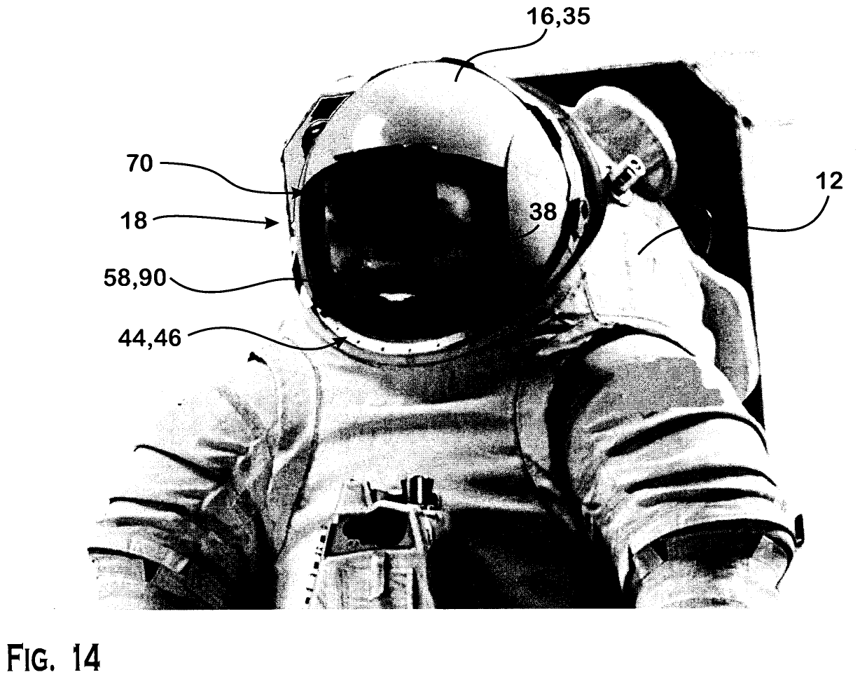

Referring to FIG. 2B and FIG. 14, in the event an avatar image 38 may be sufficiently visible 230 to another EVA crewmember, the other EVA crewmember may recognize or decode a facial nonverbal communication 232 expressed by the avatar image 38 that accurately reflects a state of the EVA crewmember's face. For instance, as shown in FIG. 14, a facial nonverbal communication 44 presented by the avatar image 38 may be a broad smile 46 that conveys a message of approval or well-being.

Referring to FIGS. 9, 10, 11 and 12, a helmet 16 for an EVA suit 12 generally may include a face shield (or bubble) 70 near the face 20 or head of an EVA crewmember 10. The face shield 70 may allow the EVA crewmember 10 to visually observe space outside of the EVA suit. For instance, the helmet 16 may include an exterior surface 72 on the space side (or outside) 74 and an interior surface 76 on the inside 78 of the helmet. The helmet 16 may be formed from one or more materials which are capable of enclosing or protecting the head on the EVA crewmember 10 and maintaining suitable environmental conditions inside 78 the helmet 16 and EVA suit. For instance, the helmet 16 may include a visor assembly 18. The visor assembly 18 may include an exterior barrier layer 80, an interior barrier layer 82, and one or more intermediate layers or spaces 84.

Referring to FIG. 9, the visor assembly 18 may include two intermediate layers 84. A first intermediate layer 86 may include a first visual display 88. Further, the first intermediate layer may include a second visual display 90. Another intermediate layer (or second intermediate layer) 92 adjacent to the exterior barrier layer 80 may include a shade 94. The shade 94 may be a mechanical device. Preferably, the shade 94 may include a semiconductor device. For example, the shade 94 may be an eshade. The eshade may include one or more LCD components that selectively darken by electronic control to reflect sunlight, including UV and IR radiation, and thus restrict direct or indirect sunlight from entering the helmet. Moreover, the first intermediate layer 86 may be disposed between the shade 94 and the interior barrier layer 82. The first visual display 88 may include a first display area 96 for a first communication channel 98 and a second display area 100 for a second communication channel 102. The first display area 96 may face inward (i.e., toward the inside of the helmet). The second display area 100 may face inward as well.

The first visual display 88 may be a head-up display (HUD), and the first display area 96 and first communication channel 98 may be open to mission control, EVA crewmembers, and other mission participants. Additionally, the second visual display 90 may be a HUD, and the second display area 100 and the second communication channel 102 may be used for displaying an avatar image of another EVA crewmember. The second visual display 90 may be spaced from the first visual display 88, and the second communication channel 102 may be open to the EVA crew. The shade (e.g., an eshade) 94 and the second visual display 90 may be connected to a dedicated power and control unit 104 via conductors 106 arranged in or along the helmet 16.

The dedicated power and control unit 104 further may include a wireless transmitter, receiver and control unit 108 for establishing a local area network. The local area network may be secured. The local area network may selectively be available to EVA crewmembers, other proximately situated team members, or other selected mission control personnel (e.g., medical personnel monitoring the EVA). Moreover, the dedicated power and control unit may be electrically or electronically connected to an auxiliary module 105 (e.g., a display and control module on the EVA crewmember's EMU).

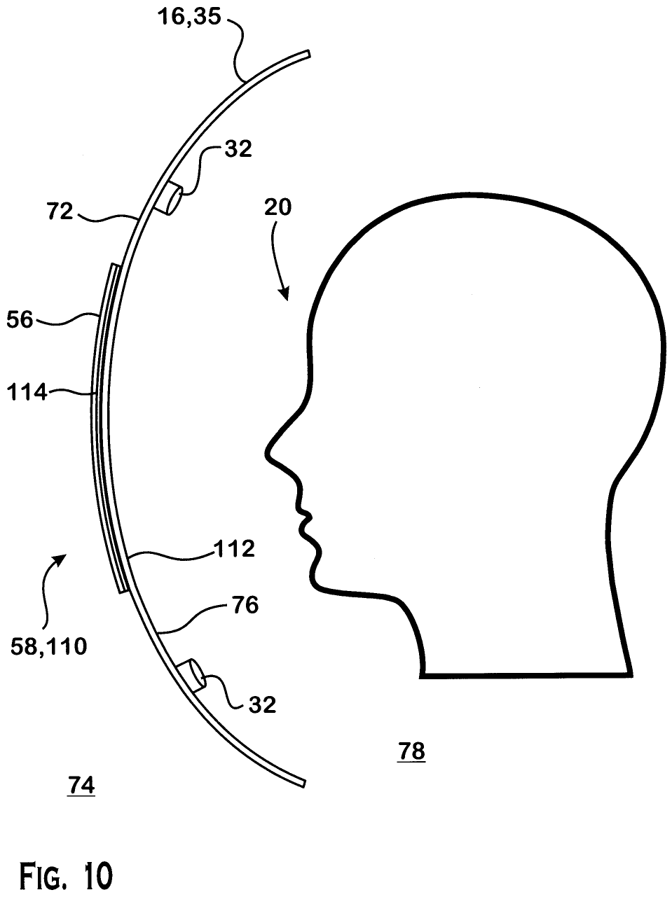

In FIG. 10 and FIG. 11 the visor assembly 18 may include an outwardly facing display area 110. Referring to FIG. 11, the avatar image 38 may be projected on to an external part 58 of the visor assembly from a projector 60 located within the helmet. In this exemplary embodiment, the ability to display the avatar image 38 externally without obstructing the field of view (FOV) of the EVA crewmember may include the arrangement of one-way illumination and non-reflective coatings 112 on the inner surface 76 of the visor assembly or helmet bubble. Additionally, another coating 114 associated with the exterior surface 72 of the visor assembly or helmet bubble may be used to direct projected light outwardly 116. Moreover, the other coating 114 may act as a thin lens as may be used in HUD systems. Accordingly, the coatings may form a holographic optical element (HOE). Additionally, projecting an avatar image from a location 118 where reflected projected light 120 returns at an offset angle that may not obstruct the crewmember's view may further reduce visual interference to the EVA crewmember.

Referring to FIG. 12, the visor assembly 18 may include three intermediate layers 84 (86, 92, 122). A first intermediate layer 86 may include a first visual display 88. A second intermediate layer 92 adjacent to the first intermediate layer 86 may include a shade 94 (e.g., an eshade). A third intermediate layer 122 disposed between the second intermediate layer 92 and the exterior barrier layer 80 may include a second visual display 90. The first visual display 88 may include a first display area 96 for a first communication channel 98, and the second visual display 90 may include a second display area 100 for a second communication channel 102.

The first display area 96 may face inward, and the second display area 100 may face outward. The first visual display 96 may be a HUD, and the second visual display 90 may include a second display area that faces outward. The second display area 100 may be used for displaying the avatar image 38. The second display area may include a transparent single-sided screen. For instance, referring to FIG. 13, the second display area 100 may allow light to pass through a transparent screen 124 from a dark side 126 to a bright side 128, while further displaying a digital image on the bright side. In a preferred embodiment, the transparent single-sided screen may include a transmissive one-side-emission OLED panel 64. For example, a suitable OLED panel technology may be a transmissive one-side-emission OLED panel developed by Toshiba Corporation. In another example, a suitable OLED panel technology may be a transparent OLED signage display manufactured by LG Electronics (e.g., Model 55EWSTF-A).

Referring to FIG. 12 and FIG. 13, arranging a transmissive one-side-emission OLED panel 64 into an intermediate layer 84 of a visor assembly 18 of an EVA suit's helmet or bubble—such that the dark side 126 may be facing the helmet interior 78 and the bright side 128 may be facing the outside (or space side) 74 of the helmet—may provide the EVA crewmember an unobstructed field of view through the face shield or bubble 70 of the visor assembly 18 while the other EVA crewmember may be able to observe the avatar image 38 being displayed on the bright side 128 of the transparent screen 124.

Although the first communication channel 98 may be open to mission control, EVA crewmembers, and other mission participants, the second communication channel 102 may be open to fewer observers (e.g., EVA crewmembers and other selected participants). Also, referring to FIG. 9 and FIG. 12, the eshade 94, the first visual display (e.g., HUD) 88, and the second visual display 90 may be connected to a dedicated power and control unit 104 via conductors 106. For instance, the conductors may be disposed in or along the interior surface 76 of the helmet. Further, the power and control unit 104 may be electrically or electronically connected to an auxiliary module 105. For instance, the auxiliary module 105 may be a display and control module 130 on the EVA crewmember's EMU.

Referring to FIG. 2A and FIG. 2B, the method 200 may involve the operation of a visor assembly for a helmet (or a bubble for an EVA suit) that includes a visual display for showing an avatar image of an EVA crewmember (222). In FIGS. 9, 11 and 12, the visual display 58, 90 may include a display area 100, 110 for displaying the avatar image 38. The display area 100 may be located in a prominent viewing location which may not obstruct an EVA crewmember's field of view 50. As shown in FIG. 9, the display area 100 for the avatar image 38 may be located on a visual display 100 inside the helmet 54 of another EVA crewmember (228). By contrast, as shown in FIG. 11, the display area 110 may be located or associated with an exterior portion of the EVA crewmember's helmet (226). For instance, the display area 58 may be located on an outside surface 56 of the face shield of the EVA crewmember's helmet 35. The display area 58 may serve as a screen for a projector 60 mounted inside the helmet 35 of the EVA crewmember. Alternatively, as shown in FIG. 12, the display area 100 may be located on an outwardly facing visual display 90 inside the helmet 35 of the EVA crewmember (224). For example, the visual display 90 may include a transmissive one-side-emission OLED panel 64 located in an intermediate layer 122 of the visor assembly. Further, the transmissive one-side-emission OLED panel may be a flexible panel. Moreover, the display area may be located on a video display unit (e.g., tablet device) located on the torso or arm of the crewmember's EVA suit, the EVA crewmember's extravehicular mobility unit (EMU), or another surface that is spaced from the crewmember's helmet 35. Also, the display area may be located on another video display unit which is remote from the EVA crewmembers (e.g., mission control).

The system and method may be validated 236 to ensure compliance with any technical or operational performance specifications. For instance, the system may be required to generate a photorealistic avatar image of a certain size and clarity, be visible at a maximum viewing distance, allow a recipient crewmember observing the avatar image to reliably decode facial nonverbal communication messages or signals, maintain a low power consumption (e.g., draw no more than 5-10 watts of power), and operate with no perceptible latency or a specified maximum latency (e.g., approximately one-half second.). Also, the capability of the photorealistic avatar to convey facial nonverbal communication may be validated. Accordingly, the photorealistic avatar may be subject to empirical challenge testing or screened for the capability of reproducing facial expressions from existing or newly developed facial expression classification systems or facial expression signaling systems. For example, a photorealistic avatar may be required to reproduce each of the facial expressions of FIG. 4 from a target EVA crewmember's face. Thus, process verification or performance qualification 234 may be completed to validate the system and method before being placed in service. In service, the system and method may be used to integrate facial nonverbal communication into EVA space operations or training 238.

In view of the above, FIGS. 2A and 2B present a process flow chart 200 for implementing a method of facial nonverbal communication in EVA or other team operations. The method may include capturing data describing the geometry and appearance of a subject (e.g., EVA crewmember's face) 202, processing the data to create a 3D profile of the subject 204, and creating a photo realistic digital twin for the subject 206. Additionally, the method 200 may include providing a helmet including a visor assembly and an interior digital camera or 3D scanning device 208. The method 200 further may include capturing a live image of the subject with the interior digital camera or 3D scanning device 210, converting the live image of the subject to an avatar image in real-time based on the digital twin and live image of the subject 212, and translating the avatar image into an electronic signal 214. Also, the method may include transmitting the electronic signal to a target device 216, receiving the electronic signal at the target device 218, and outputting the avatar image of the electronic signal to a visual display 220. The method 200 further may include showing the avatar image on a display area of the visual display 222. For instance, the method may include displaying the avatar image on an outwardly facing display area which may include a transparent single-sided display located on or in the helmet 224. Additionally, the method may include projecting the avatar image onto an outwardly facing display area on or in the helmet 226. Also, the method may include displaying the avatar image on a display area spaced from the helmet 228. Moreover, the method 200 may include visual observation by a recipient of the avatar image on the visual display in real-time 230, and recognition by recipient of non-verbal communication from the subject based on visual observation of the avatar image 232. Further still, the method 200 may include a process qualification 234 before entering operational service. For instance, the method may undergo validation testing for compliance with applicable technical or operational performance specifications 236. The method may further include the integration of facial nonverbal communication, including the development of operation specific protocol, into EVA space operations or training 238.

Although the foregoing disclosure is directed toward a system, apparatus, and method for integration of facial nonverbal communication between EVA crew during space operations and training, the disclosure may be adapted and applied to other settings involving a team of helmeted operators. For example, without limitation, the system, apparatus, and method may be adapted and applied to emergency rescue and firefighter helmets or personal protective equipment and associated fire and rescue operations, as well as personal protective equipment for healthcare delivery in clinical settings involving infectious disease. The system, apparatus, and method also may be adapted and applied to motorcycle helmets.

While it has been illustrated and described what at present are considered to be embodiments of the present invention, it will be understood by those skilled in the art that various changes and modifications may be made, and equivalents may be substituted for elements thereof without departing from the true scope of the invention. For example, other display devices or projection systems may be used. Additionally, features and/or elements from any embodiment may be used singly or in combination with other embodiments. Therefore, it is intended that this invention not be limited to the particular embodiments disclosed herein, but that it have the full scope defined by the language of the following claims, and equivalents thereof.

What is claimed is:

1. A method for integration of facial nonverbal communication in extravehicular activity comprising:
providing a photo realistic digital twin of an EVA crewmember;
providing a helmet for an EVA suit, the helmet comprising
a visor assembly which comprises
a first visual display for a first communication channel, the first visual display comprising a first display area facing the helmet, and
a second visual display for a second communication channel, the second visual display being spaced from the first visual display, the second visual display comprising a second display area, the second display area facing away from the helmet, and
a shade disposed between the first visual display and the second visual display;
and
a digital camera disposed inside the helmet;
capturing a live image with the digital camera;
creating an avatar image of the EVA crewmember in real-time based on the live image and the photo realistic digital twin for the EVA crewmember;
presenting the avatar image of the EVA crewmember in real-time on the second display area; and
transmitting a facial nonverbal communication signal in the avatar image to the second display area.

2. The method of claim 1, wherein the shade comprises an LCD for reflecting sunlight away from the helmet.

3. The method of claim 2, wherein the first display area is a HUD.

4. The method of claim 3, wherein the second display area comprises a transmissive one-side-emission OLED panel.

5. An apparatus for integration of facial nonverbal communication in extravehicular activity comprising:
a helmet for an EVA suit, the helmet comprising
a visor assembly which comprises
a first visual display for a first communication channel, the first visual display comprising a first display area facing the helmet, and
a second visual display for a second communication channel, the second visual display being spaced from the first visual display, the second visual display comprising a second display area, the second display area facing away from the helmet, and
a shade disposed between the first visual display and the second visual display; and
a digital camera disposed inside the helmet.

6. The apparatus of claim 5, wherein the shade comprises an LCD for reflecting sunlight away from the helmet, the first display area is a HUD, and the second display area comprises a transmissive one-side-emission OLED panel.

7. A system for integration of facial nonverbal communication in extravehicular activity comprising:
the apparatus of claim 5, and a photo realistic digital twin of an EVA crewmember.

8. The system of claim 7, further comprising a protocol for facial nonverbal communication in EVA space operations or training.
